(19) United States
(12) Patent Application Publication
(10) Pub. No.: US 2026/0116159 A1
(43) Pub. Date: Apr. 30, 2026

(54) SUNROOF DEVICE

(71) Applicant: YACHIYO INDUSTRY CO., LTD., Sayama-shi, Saitama (JP)

(72) Inventors: Ryuta HARA, Sakura-shi, Tochigi (JP); Tamotsu NISHIBA, Sakura-shi, Tochigi (JP)

(21) Appl. No.: 18/717,297

(22) PCT Filed: Oct. 19, 2022
(86) PCT No.: PCT/JP2022/038903

§ 371 Date: Dec. 30, 2024

(30) Foreign Application Priority Data
Dec. 9, 2021 (JP) 2021-200251

(51) Int. Cl. B60J 7/043; B60J 7/057; E05D 15/10; E05F 15/643; E05F 15/662

(52) U.S. Cl. CPC B60J 7/0435; B60J 7/0573; E05D 15/1047; E05F 15/643; E05F 15/662; E05Y 2201/682; E05Y 2900/542

(57) ABSTRACT

A sunroof device includes a coupling member coupling the movable panel to a slider, and an elevating mechanism configured to raise and lower a rear end of the movable panel. The elevating mechanism includes a cam groove provided in the slider, the cam groove being a bottomed cam groove that is open to one side over an entire length thereof, and a guide pin provided on the coupling member to protrude into the cam groove from a side. A slot is formed in a bottom wall of the slider defining the cam groove, the slot penetrating the bottom wall and extending in an extension direction of the cam groove to have a length shorter than a length of the cam groove. The slot is provided in a part of the bottom wall where the guide pin is positioned when the movable panel is in the tilt up position.

### TECHNICAL FIELD

The present disclosure relates to a sunroof device for at least partially opening and closing an opening formed in a roof of a vehicle with a movable panel.

### BACKGROUND ART

A sunroof device may be provided on a roof of a vehicle. In the sunroof device, the cover (movable panel) takes a fan position (ventilation position) by fully or partially open the opening of the roof or raising (tilting up) the rear end, for example. To move the movable panel, a guide link provided with a slide track (cam groove) along which a guide pin can move is used, for example (see Patent Document 1).

The sunroof device described in Patent Document 1 is a slide/tilt type roof in which the guide pin moves in the cam groove and the movable panel moves below an outer panel of the fixed roof. A guide slot (stay) is mounted to the lower surface of the movable panel, and the stay is provided with a cam groove with which the guide pin of the rear slider is displaceably engaged. The stay includes a support part made of steel and a resin lining overmolded onto the support part. The cam groove is defined by the resin lining, and in a part of an upper edge of the cam groove, a damping section is formed by a thick part of the resin lining which is formed with an elongated groove.

### PRIOR ART DOCUMENT(S)

### Patent Document(s)

Patent Document 1: DE202004016557U1

### SUMMARY OF THE INVENTION

### Task to be Accomplished by the Invention

In the sunroof device described in Patent Document 1, when the guide pin is positioned in the damping section, the guide pin is flexibly held in the up-down direction by the resin lining, whereby the effect of damping the vibration of the movable panel can be expected. However, in the case of a configuration where the cam groove has a bottomed shape opened to a side and the guide pin does not penetrate the cam groove, the damping section cannot impart flexibility to the thick part of the resin lining. Therefore, the vibration damping effect cannot be obtained.

The vibration of the movable panel tends to increase when the movable panel is in the tilt up position. However, in this sunroof device, the guide pin is positioned in the end portion of the cam groove when the movable panel is in the tilt up position, and the end portion of the cam groove has a keyhole opening. Therefore, in this configuration, the vibration damping effect cannot be obtained when the movable panel is in the tilt up position.

In view of such background, an object of the present invention is to provide a sunroof device which, even if the cam groove has a bottomed structure, can damp vibration when the movable panel is in the tilt up position.

### Means to Accomplish the Task

To achieve such an object, one embodiment of the present invention is a sunroof device (10, 110) for at least partially opening and closing an opening (3) formed in a roof (2) of a vehicle (1) with a movable panel (11, 111), the sunroof device comprising: a frame-shaped frame (20) configured to be disposed below the roof to be aligned with the opening; a slider (27, 125) provided on the frame to be slidable in a front-rear direction; a coupling member (29, 32, 129) coupling the movable panel to the slider; and an elevating mechanism (30, 130) provided between the slider and the coupling member and configured to raise and lower a rear end of the movable panel to tilt the movable panel between a closed position where the movable panel closes the opening and a tilt up position where a rear portion of the movable panel is positioned above the opening, wherein the elevating mechanism comprises: a cam groove (35, 135) provided in one of the slider and the coupling member, the cam groove being a bottomed cam groove that is open to one side over an entire length thereof; and an at least one guide pin (36, 136) provided on an other of the slider and the coupling member to protrude into the cam groove from a side, and at least one slot (47, 147) is formed in a bottom wall (46, 146) of the one of the slider and the coupling member defining the cam groove, the at least one slot penetrating the bottom wall and extending in an extension direction of the cam groove to have a length shorter than a length of the cam groove, and the at least one slot being provided in a part of the bottom wall where the at least one guide pin is positioned when the movable panel is in the tilt up position.

According to this configuration, when the movable panel is in the tilt up position, the at least one guide pin of the elevating mechanism supporting the movable panel is supported by the part of the cam groove where the stiffness is reduced due to the slot. Therefore, when the movable panel in the tilt up position vibrates, the vibration of the movable panel is damped by the elevating mechanism. Thus, the vibration sound of the movable panel is suppressed. Note that since the length of the at least one slot is shorter than the length of the cam groove, the stiffness of the entire cam groove can be ensured though the slot is provided in the bottom wall.

In the above aspect, preferably, the at least one slot (47, 147) is provided in a part of the bottom wall where the at least one guide pin is positioned when the movable panel is in the closed position.

According to this configuration, when the movable panel is in the closed position also, the at least one guide pin is supported by the part of the cam groove where the stiffness is reduced due to the slot. Therefore, when the movable panel in the closed position vibrates also, the vibration of the movable panel is damped by the elevating mechanism.

In the above aspect, preferably, the movable panel (11, 111) is supported on the frame to be movable between the closed position and an open position which is positioned in a moving direction of the slider with respect to the closed position in plan view, and the at least one slot (47, 147) is not provided in a part of the bottom wall where the at least one guide pin is positioned when the movable panel is in the open position.

When the at least one guide pin is supported by the part of the cam groove where the slot is provided, the vibration of the movable panel is damped while the movable panel becomes easier to vibrate. According to this configuration, it is possible to make the movable panel hard to vibrate when the movable panel is in the open position.

In the above aspect, preferably, the coupling member includes a link member (32) having one end pivotably coupled to the movable panel, the guide pin (36) includes two guide pins (36) provided on the link member at positions spaced from each other in the extension direction of the cam groove, and the at least one slot (47) is provided in each of parts of the bottom wall where the two guide pins are positioned when the movable panel is in the tilt up position such that the slots are spaced from each other.

According to this configuration, when the movable panel is in the tilt up position, the link member is supported by the cam groove with a lower support stiffness compared to the case where the slot is provided in only the part of the bottom wall where one of the two guide pins is positioned. Therefore, when the movable panel in the tilt up position vibrates, the vibration of the movable panel is damped more effectively by the elevating mechanism.

In the above aspect including the link member, preferably, the at least one slot (47) is provided in a part of the bottom wall (46) where one of the two guide pins (36) is positioned when the movable panel (11) is in the closed position and is not provided in a part of the bottom wall where an other of the two guide pins is positioned when the movable panel is in the closed position.

According to this configuration, when the movable panel is in the closed position, the link member is supported by the cam groove with a higher support stiffness compared to the case where the slot is provided to each of the parts of the bottom wall where the two guide pins are positioned. Therefore, it is possible to make the movable panel hard to vibrate when the movable panel is in the closed position.

In the above aspect including the link member, preferably, the slider (27) includes a sheet metal member (43) and a resin member (44) integrally formed on the sheet metal member, and the cam groove (35) is defined by the resin member so as to penetrate the sheet metal member in a plate thickness direction.

According to this configuration, since the cam groove is defined by the resin member, it is possible to reduce the sliding resistance of the guide pin. Also, since the cam groove is defined to penetrate the sheet metal member in the plate thickness direction, the stiffness of the cam groove against the force inputted from the guide pin is supplemented by the sheet metal member.

In the above aspect including the link member, preferably, the slider (27) includes a pair of vertical wall portions (41) disposed on both sides of the link member (32) and coupled to each other, the cam groove (35) being formed in each of the pair of vertical wall portions, the at least one guide pin (36) protrudes from the link member to both sides so as to protrude into the cam grooves, and the slot (47) is formed in the bottom wall of each of the pair of vertical wall portions (46).

According to this configuration, since the both ends of the guide pin are supported by the cam grooves of the pair of vertical wall portions, it is possible to increase the panel support capacity of the guide pin. Also, since the slot is provided in the bottom wall of each of the pair of vertical wall portions, the guide pin can support a vertical load in a well-balanced manner.

### Effect of the Invention

According to the above aspect, it is possible to provide a sunroof device which, even if the cam groove has a bottomed structure, can damp vibration when the movable panel is in the tilt up position.

### BRIEF DESCRIPTION OF THE DRAWINGS

FIG. 1 is a perspective view showing a closed state of a sunroof device according to the first embodiment;

FIG. 2 is a perspective view showing a tilt up state of the sunroof device shown in FIG. 1;

FIG. 3 is a perspective view showing an open state of the sunroof device shown in FIG. 1;

FIG. 4 is a sectional view taken along line IV-IV in FIG. 2;

FIG. 5 is a sectional view taken along line V-V in FIG. 4;

FIG. 6 is an operation explanatory diagram showing (a) a closed state, (b) a tilt up state, and (c) an open state of an elevating mechanism shown in FIG. 4;

FIG. 7 is an operation explanatory diagram of a rear slider, showing (a) the closed state, (b) the tilt up state, and (c) the open state corresponding to FIG. 6;

FIG. 8 is a perspective view showing an open state of a sunroof device according to the second embodiment;

FIG. 9 is an operation explanatory diagram showing (a) a tilt up state, (b) a closed state, and (c) an open state of the sunroof device shown in FIG. 8;

FIG. 10 is a sectional view taken along line X-X of FIG. 9; and

FIG. 11 is an operation explanatory diagram of an elevating mechanism, showing (a) the tilt up state, (b) the closed state, and (c) the open state corresponding to FIG. 9.

### MODE(S) FOR CARRYING OUT THE INVENTION

In the following, embodiments of the present invention will be described in detail with reference to the drawings.

### First Embodiment

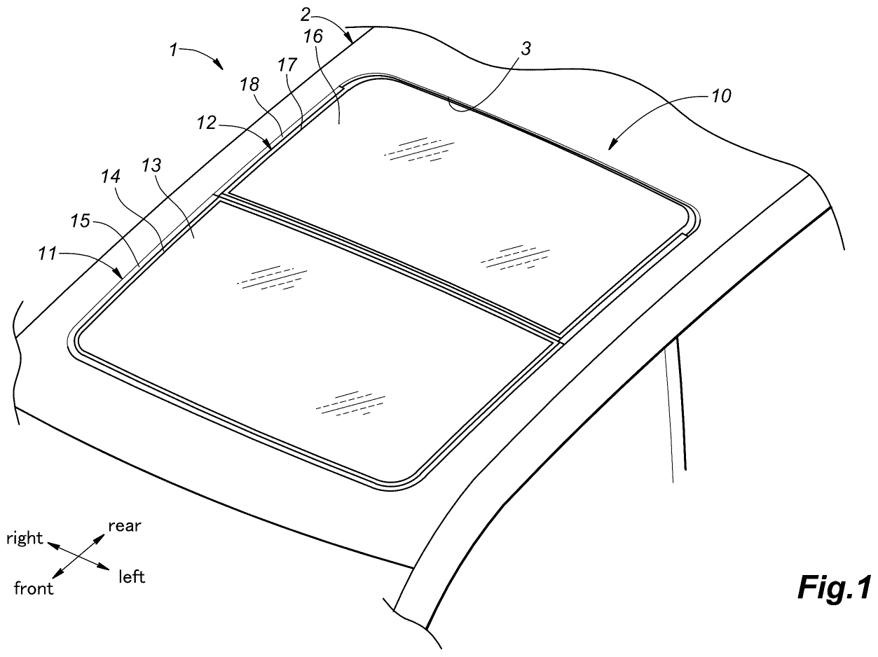

First, a first embodiment of the present invention will be described with reference to FIGS. 1 to 7. FIG. 1 is a perspective view showing a closed state of a sunroof device 10 installed on a roof 2 of an automobile 1. The roof 2 of the automobile 1 is formed with a rectangular opening 3, and the sunroof device 10 is installed on the roof 2 so as to close the opening 3. In the following, the front-rear, left-right, and up-down directions are defined based on the automobile 1 having the sunroof device 10 installed on the roof 2. The sunroof device 10 is substantially bilaterally symmetric, and details of bilaterally symmetric structures will be described with the right side shown in the drawings.

The sunroof device 10 includes a front panel 11 for closing a front portion of the opening 3 and a rear panel 12 for closing a rear portion of the opening 3. The front panel 11 and the rear panel 12 are arranged along the roof 2 so that their upper surfaces are aligned with the upper surface of the roof 2. The front panel 11 is a movable panel that is movable relative to the roof 2, while the rear panel 12 is a fixed panel that is unmovable relative to the roof 2.

The front panel 11 includes a front panel main body 13 composed of a glass plate and an annular front molding 14 made of resin and provided on an outer peripheral edge of the front panel main body 13. Between the outer peripheral edge of the front molding 14 and the edge part of the opening 3, a front seal part 15 made of an elastic material is provided. The rear panel 12 includes a rear panel main body 16 composed of a glass plate and an annular rear molding 17 made of resin and provided on an outer peripheral edge of the rear panel main body 16. Between the outer peripheral edge of the rear molding 17 and the edge part of the opening 3, a rear seal part 18 made of an elastic material is provided. The front seal part 15 and the rear seal part 18 cooperate to form an annular seal part around the outer circumference of the front panel 11 and the rear panel 12 and to form a seal part between the front panel 11 and the rear panel 12.

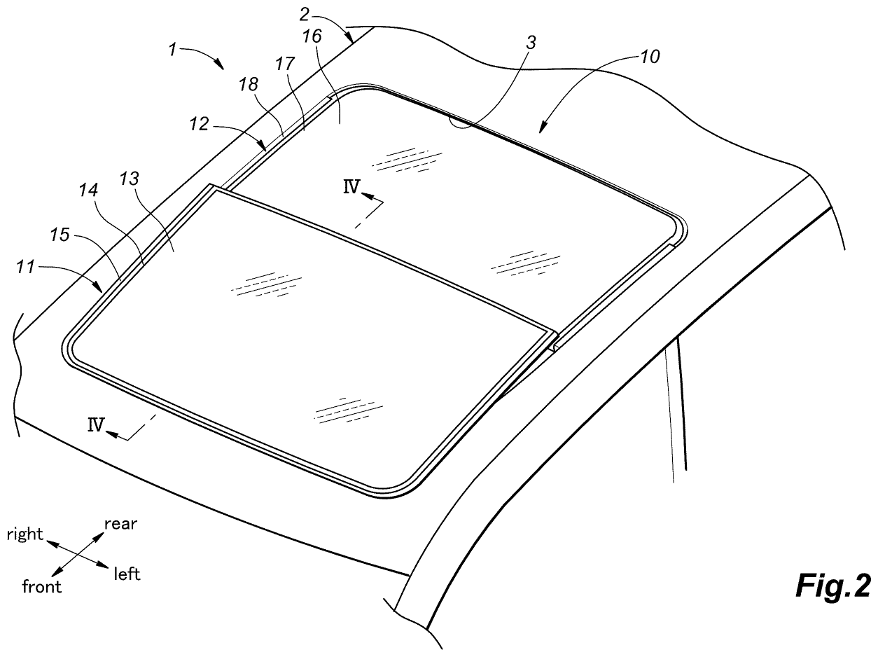

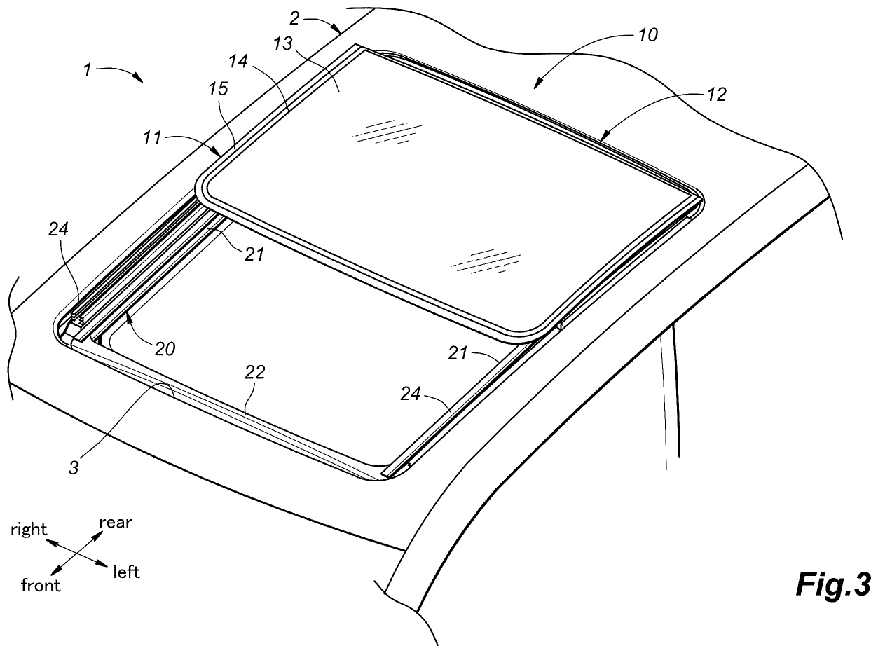

When driven in the opening direction by a known slide mechanism, the front panel 11 moves from a closed position shown in FIG. 1 where the front panel 11 closes the front portion of the opening 3 to a tilt up position shown in FIG. 2 where the rear portion of the front panel 11 is flipped up. When further driven in the opening direction, the front panel 11 slides rearward over the rear panel 12 and moves to an open position shown in FIG. 3 where the front panel 11 overlaps above the rear panel 12 and opens the front portion of the opening 3. On the other hand, when driven in the closing direction by the slide mechanism, the front panel 11 slides forward above the rear panel 12 and moves from the open position shown in FIG. 3 to the closed position shown in FIG. 1 via the tilt up position shown in FIG. 2. In this way, the front panel 11 is slidable between the closed position shown in FIG. 1 and the open position shown in FIG. 3, and the sunroof device 10 can partially open and close the front portion of the opening 3. The sunroof device 10 of the present embodiment is an outer slide sunroof in which the front panel 11 moves above (on the outer side of) the roof 2.

As shown in FIG. 3, a frame-shaped frame 20 for supporting the front panel 11 and the rear panel 12 is mounted below the roof 2 to be aligned with the opening 3 of the roof 2. The frame 20 has a rectangular annular shape along the opening 3 and includes left and right side members 21 extending in the front-rear direction along the side edges of the opening 3, and a front cross member 22 and a rear cross member which couple the front ends of the left and right side members 21 to each other and the rear ends of the same to each other, respectively. Each side member 21 is integrally provided with a guide rail 24 extending in the front-rear direction.

At a laterally intermediate portion of the rear cross member, a drive source including an electric motor and a speed reduction mechanism is mounted. An output end of the drive source is engaged with left and right push-pull cables for driving the front panel 11. The push-pull cables extend from the output end of the drive source in outboard directions along the rear cross member, are curved forward by passing through left and right guide pipes, and then extend forward inside the left and right guide rails 24.

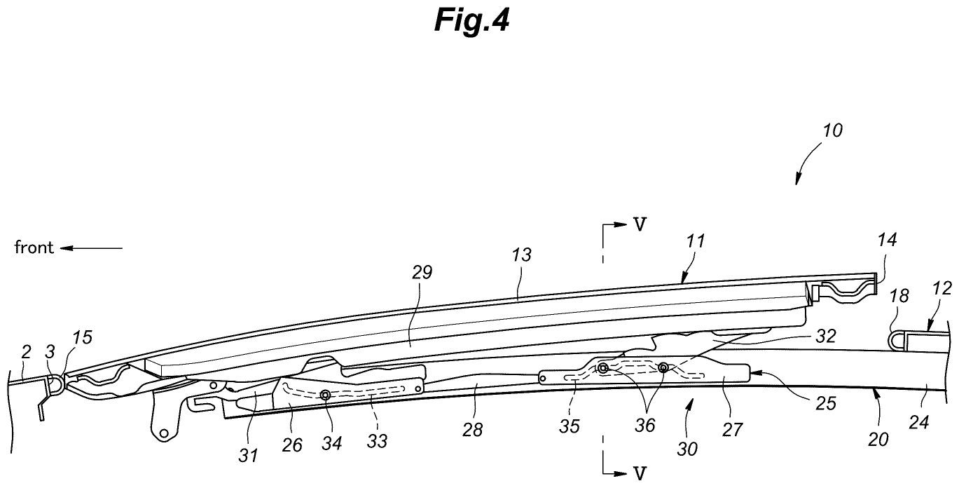

FIG. 4 is a sectional view taken along line IV-IV in FIG. 2. As shown in FIG. 4, a slider 25 is provided in each guide rail 24 to be slidable in the front-rear direction. The slider 25 is joined to the push-pull cable. The slider 25 includes a front slider 26, a rear slider 27 disposed rearward of the front slider 26, and a coupling slider 28 that couples the front slider 26 and the rear slider 27. The front slider 26 and the rear slider 27 are coupled by the coupling slider 28 so as to be pivotable relative to each other about lateral axes and to be unmovable toward and away from each other in the front-rear direction. Thus, when pushed and pulled by the push-pull cable, the front slider 26 and the rear slider 27 slide forward and rearward in synchronization.

On the lower surface of the front panel 11, left and right stays 29 for coupling the front panel 11 to the sliders 25 are fixed. Each stay 29 is composed of a metal plate member extending in the front-rear direction. The stay 29 functions as a coupling member that couples the front panel 11 to the slider 25. Between the slider 25 and the stay 29, an elevating mechanism 30 for raising and lowering the front panel 11 is provided.

The elevating mechanism 30 tilts the front panel 11 between the closed position where the front panel 11 closes the opening 3 and the tilt up position where the rear portion of the front panel 11 is positioned above the opening 3. The tilting center at this time is near the front end of the front panel 11. Namely, the elevating mechanism 30 raises and lowers the rear end of the front panel 11. Also, the elevating mechanism 30 tilts the front panel 11 between the tilt up position and a raised position where both the front portion and the rear portion are positioned above the opening 3. The tilting center at this time is near the rear end of the front panel 11. Namely, the elevating mechanism 30 raises and lowers the front end of the front panel 11. When the front panel 11 is between the raised position and the open position, the elevating mechanism 30 maintains the front panel 11 in a raised state. Note that in plan view, the open position is located rearward of the closed position, which is the moving direction of the slider 25.

The front slider 26 is coupled to a front portion of the stay 29 via a front link member 31. The rear slider 27 is coupled to a rear portion of the stay 29 via a rear link member 32. The front link member 31 is connected to the stay 29 to be pivotable about a lateral axis. The front slider 26 is formed with a bottomed front cam groove 33 that is open to one side over the entire length thereof. The front cam groove 33 has a length in the front-rear direction and the up-down direction. The front link member 31 is integrally provided with a front guide pin 34 that protrudes laterally. With the front guide pin 34 protruding into the front cam groove 33 from a side, the front link member 31 is slidably connected to the front slider 26. The front slider 26 functions as a coupling member that couples the front panel 11 to the slider 25.

The rear link member 32 is connected to the stay 29 to be pivotable about a lateral axis. The rear slider 27 is formed with a bottomed rear cam groove 35 that is open to one side over the entire length thereof. The rear cam groove 35 has a length in the front-rear direction and the up-down direction. The rear link member 32 is integrally provided with two rear guide pins 36 that protrude laterally. With the rear guide pins 36 protruding into the rear cam groove 35 from a side, the rear link member 32 is slidably connected to the rear slider 27. The two rear guide pins 36 are disposed in positions spaced from each other in the extension direction of the rear cam groove 35. The rear link member 32 functions as a coupling member that couples the front panel 11 to the slider 25.

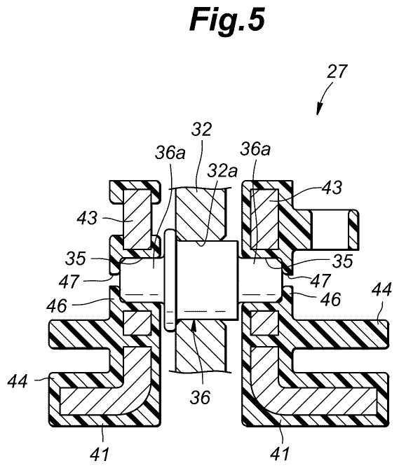

FIG. 5 is a sectional view taken along line V-V in FIG. 4. As shown in FIG. 5, the rear slider 27 is provided with a pair of vertical wall portions 41 disposed to be laterally spaced from each other so as to interpose the rear link member 32 therebetween. The pair of vertical wall portions 41 are joined to each other. Each of the vertical wall portions 41 includes a sheet metal member 43 having an L-shaped cross-sectional shape and extending in the front-rear direction and a resin member 44 integrally formed on the sheet metal member 43. In a part of the sheet metal member 43 where the rear cam groove 35 is disposed, an opening having a width greater than the width (height) of the rear cam groove 35 is formed so as to penetrate it, and the rear cam groove 35 is defined by the resin member 44 and penetrates the sheet metal member 43 in the plate thickness direction in this opening.

The rear cam grooves 35 are formed in the opposing surfaces of the pair of vertical wall portions 41 such that the open ends thereof oppose each other. The rear link member 32 is formed with two pin retaining holes 32a so as to penetrate it in the left-right direction. In each pin retaining hole 32a, one of the rear guide pins 36 is fitted. Each rear guide pin 36 protrudes to both sides from the both side surfaces of the rear link member 32 and the protruding ends 36a thereof protrude into the rear cam grooves 35 of the two vertical wall portions 41.

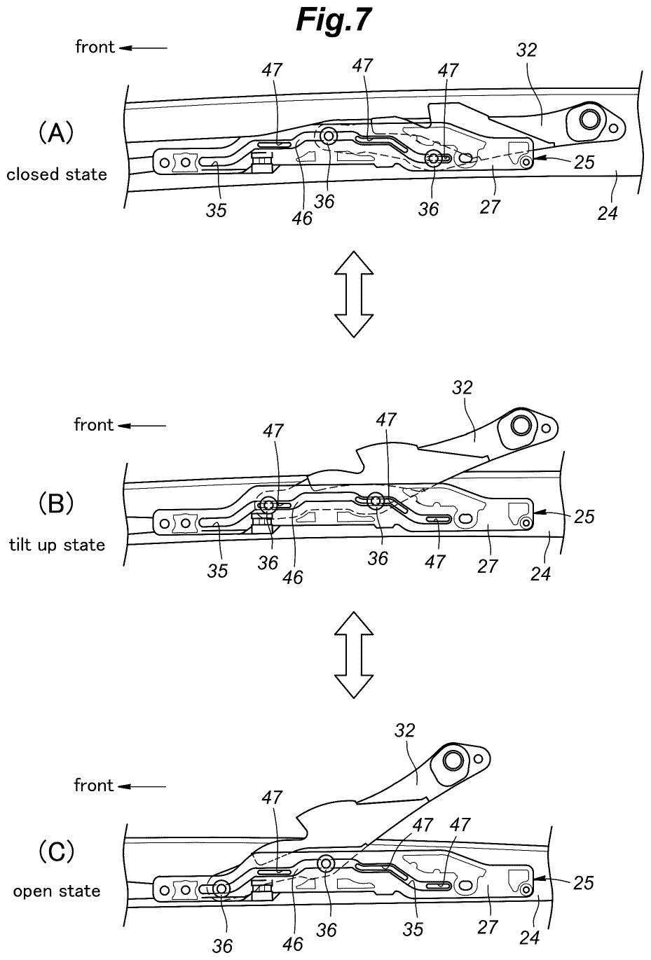

A bottom wall 46 of each rear cam groove 35, namely, a thin part of the resin member 44 defining the bottom of the rear cam groove 35 is formed with a slot 47 having a width narrower than the width (height) of the rear cam groove 35. The slot 47 extends in the extension direction of the rear cam groove 35. The slot 47 has a length shorter than the length of the rear cam groove 35 in the extension direction. In the bottom wall 46 of each rear cam groove 35, multiple slots 47 are formed at intervals in the extension direction of the rear cam groove 35 (see FIG. 7). In the present embodiment, three slots 47 are formed in the bottom wall 46 of each rear cam groove 35. The three slots 47 of one of the two vertical wall portions 41 are formed in positions aligned with the three slots 47 of the other of the two vertical wall portions 41.

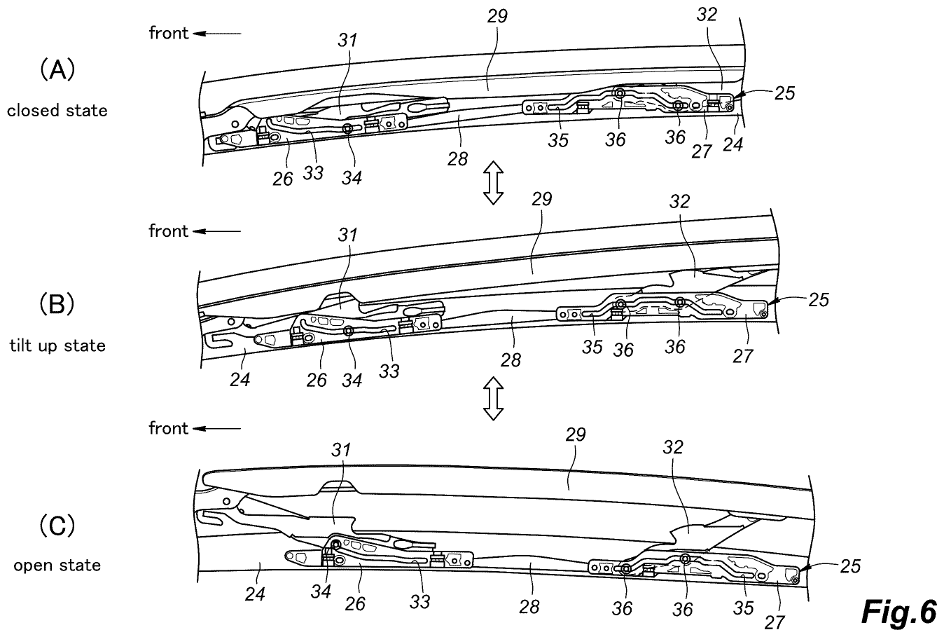

FIG. 6 is an operation explanatory diagram showing (a) the closed state, (b) the tilt up state, and (c) the open state of the elevating mechanism 30 shown in FIG. 4. As shown in FIG. 6(a), the closed state of the sunroof device 10 is a state in which the slider 25 is positioned most forward. The front guide pin 34 is positioned in a rear portion of the front cam groove 33, and the two rear guide pins 36 are positioned in a rear portion of the rear cam groove 35. The front link member 31 and the rear link member 32 are in the most collapsed posture. The front panel 11 is in the lowest position and extends in parallel with the roof 2.

As shown in FIG. 6(b), in the tilt up state of the sunroof device 10, the slider 25 is positioned more rearward compared to the state of FIG. 6(a). The front guide pin 34 is positioned in an intermediate portion of the front cam groove 33, and the two rear guide pins 36 are positioned in an intermediate portion of the rear cam groove 35. While the front link member 31 is in the collapsed posture, the rear link member 32 is more raised compared to the state of FIG. 6(a). The front panel 11 is tilted relative to the roof 2, with the rear portion thereof flipped up.

As shown in FIG. 6(c), the open state of the sunroof device 10 is a state in which the slider 25 is positioned most rearward. The front guide pin 34 is positioned in a front portion of the front cam groove 33, and the two rear guide pins 36 are positioned in a front portion of the rear cam groove 35. The front link member 31 is raised, and the rear link member 32 is more raised compared to the state of FIG. 6(b). The front panel 11 is in the highest position and extends in parallel with the roof 2. Note that when the front panel 11 is in the raised position, the height and the extension direction of the front panel 11 relative to the roof 2 are the same as in the open state of FIG. 6(c).

FIG. 7 is an operation explanatory diagram of the rear slider 27, showing (a) the closed state, (b) the tilt up state, and (c) the open state corresponding to FIG. 6. As shown in FIG. 7(a), no slot 47 is provided in the part of the bottom wall 46 of the rear cam groove 35 where the forward one of the rear guide pins 36 is positioned when the sunroof device 10 is in the closed state. On the other hand, the part of the bottom wall 46 where the rearward one of the rear guide pins 36 is positioned is provided with a slot 47.

As shown in FIG. 7(b), each of the parts of the bottom wall 46 where the two rear guide pins 36 are positioned when the sunroof device 10 is in the tilt up state is provided with a slot 47. As shown in FIG. 7(c), no slot 47 is provided in the parts of the bottom wall 46 where the two rear guide pins 36 are positioned when the sunroof device 10 is in the open state.

In other words, the bottom wall 46 of the rear cam groove 35 is formed with three slots 47 at three locations spaced from each other in the extension direction of the rear cam groove 35. These slots 47 each extend in the extension direction of the rear cam groove 35 to have a length shorter than the length of the rear cam groove 35.

The sunroof device 10 is configured as described above. Next, operation and effects of the sunroof device 10 will be described.

As shown in FIG. 7(b), the slots 47 are provided in the parts of the bottom wall 46 where the rear guide pins 36 are positioned when the front panel 11 is in the tilt up position. Thereby, when the front panel 11 is in the tilt up position, the rear guide pins 36 of the elevating mechanism 30 supporting the front panel 11 are supported by the parts of the rear cam groove 35 where the stiffness is reduced due to the slots 47. Therefore, when the front panel 11 in the tilt up position vibrates, the vibration of the front panel 11 is damped by the elevating mechanism 30. Thus, the vibration sound of the front panel 11 is suppressed. Note that since the length of the at least one slot 47 is shorter than the length of the rear cam groove 35, the stiffness of the entire rear cam groove 35 is ensured though the slot 47 is provided in the bottom wall 46.

As shown in FIG. 7(a), the slots 47 are also provided in the parts of the bottom wall 46 where the rear guide pins 36 are positioned when the front panel 11 is in the closed position. Thereby, when the front panel 11 is in the closed position also, the rear guide pins 36 are supported by the parts of the rear cam groove 35 where the stiffness is reduced due to the slots 47. Thus, when the front panel 11 in the closed position vibrates also, the vibration of the front panel 11 is damped by the elevating mechanism 30.

As described above, the front panel 11 is supported by the frame 20 to be movable between the closed position and the open position which is positioned in the moving direction of the rear slider 27 with respect to the closed position in plan view. When the rear guide pins 36 are supported by the parts of the rear cam groove 35 where the slots 47 are provided, the vibration of the front panel 11 is damped while the front panel 11 becomes easier to vibrate. In the present embodiment, as shown in FIG. 7(c), no slot 47 is provided in the parts of the bottom wall 46 where the rear guide pins 36 are positioned when the front panel 11 is in the open position. Therefore, the front panel 11 is hard to vibrate when the front panel 11 is in the open position.

As shown in FIG. 5 to FIG. 7, the rear link member 32 having one end pivotably coupled to the front panel 11 is provided as a coupling member that couples the front panel 11 to the slider 25. Also, the two rear guide pins 36 are provided on the rear link member 32 at positions spaced from each other in the extension direction of the rear cam groove 35. Further, as shown in FIG. 7(b), the slots 47 are respectively provided in the parts of the bottom wall 46 where the two rear guide pins 36 are positioned when the front panel 11 is in the tilt up position so as to be spaced from each other. Thereby, when the front panel 11 is in the tilt up position, the rear link member 32 is supported by the rear cam groove 35 with a lower support stiffness compared to the case where the slot 47 is provided only on the part of the bottom wall 46 where one of the two rear guide pins 36 is positioned. Therefore, when the front panel 11 in the tilt up position vibrates, the vibration of the front panel 11 is more effectively damped by the elevating mechanism 30.

As shown in FIG. 7(a), the slot 47 is provided in the part of the bottom wall 46 where one (in the present embodiment, the rear-side one) of the rear guide pins 36 is positioned when the front panel 11 is in the closed position. On the other hand, no slot 47 is provided in the part of the bottom wall 46 where the other (in the present embodiment, the front-side one) of the rear guide pins 36 is positioned when the front panel 11 is in the closed position. Thereby, when the front panel 11 is in the closed position, the rear link member 32 is supported by the rear cam groove 35 with a higher support stiffness compared to the case where the slots 47 are provided in both the parts of the bottom wall 46 where the two rear guide pins 36 are positioned. Therefore, the front panel 11 is hard to vibrate when the front panel 11 is in the closed position.

As shown in FIG. 5, the rear slider 27 includes the sheet metal member 43 and the resin member 44 integrally formed on the sheet metal member 43. Further, the rear cam groove 35 is defined by the resin member 44 so as to penetrate the sheet metal member 43 in the plate thickness direction. Since the rear cam groove 35 is defined by the resin member 44, the sliding resistance of the rear guide pins 36 is reduced. Also, since the rear cam groove 35 is defined to penetrate the sheet metal member 43 in the plate thickness direction, the stiffness of the rear cam groove 35 against the force inputted from the rear guide pin 36 is supplemented by the sheet metal member 43.

The rear slider 27 includes the pair of vertical wall portions 41 disposed on both sides of the rear link member 32 and coupled to each other. The rear cam groove 35 is formed in each of the pair of vertical wall portions 41, and each rear guide pin 36 protrudes from the rear link member 32 to both sides so as to protrude into the rear cam grooves 35. Further, the slots 47 are formed in the bottom wall 46 of each of the pair of vertical wall portions 41. In this way, since the both ends of the rear guide pin 36 are supported by the rear cam grooves 35 of the pair of vertical wall portions 41, the panel support capacity of the rear guide pin 36 increases. Also, since the slots 47 are provided in the bottom wall 46 of each of the pair of vertical wall portions 41, a vertical load is supported by the rear guide pins 36 in a well-balanced manner.

### Second Embodiment

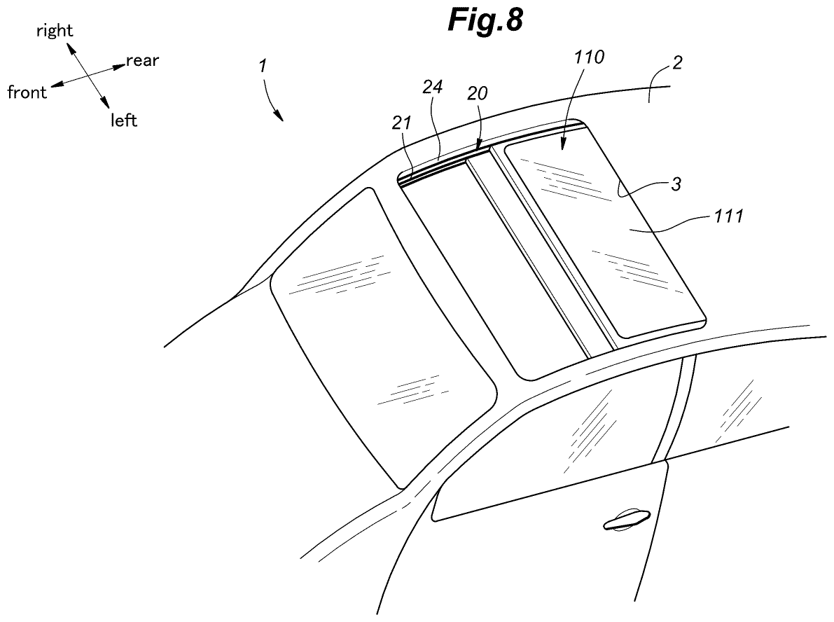

Next, with reference to FIG. 8 to FIG. 11, a second embodiment of the present invention will be described. The elements same as or similar to those of the first embodiment are denoted by the same reference signs and identical, and the description overlapping with the first embodiment will be omitted.

FIG. 8 is a perspective view showing an open state of a sunroof device 110 according to the second embodiment. The sunroof device 110 includes one movable roof panel 111 for closing the opening 3. The sunroof device 110 of the present embodiment is an inner slide sunroof in which the movable roof panel 111 moves under (on the inner side of) the roof 2. When moving to the open position which is positioned rearward of the closed position in plan view, the movable roof panel 111 takes a tilt down posture in which the movable roof panel 111 is pivoted such that the rear portion thereof is lowered down, as shown in the drawing. On the other hand, the movable roof panel 111 is configured to be capable of taking a tilt up posture in which the rear portion is flipped up from the closed position.

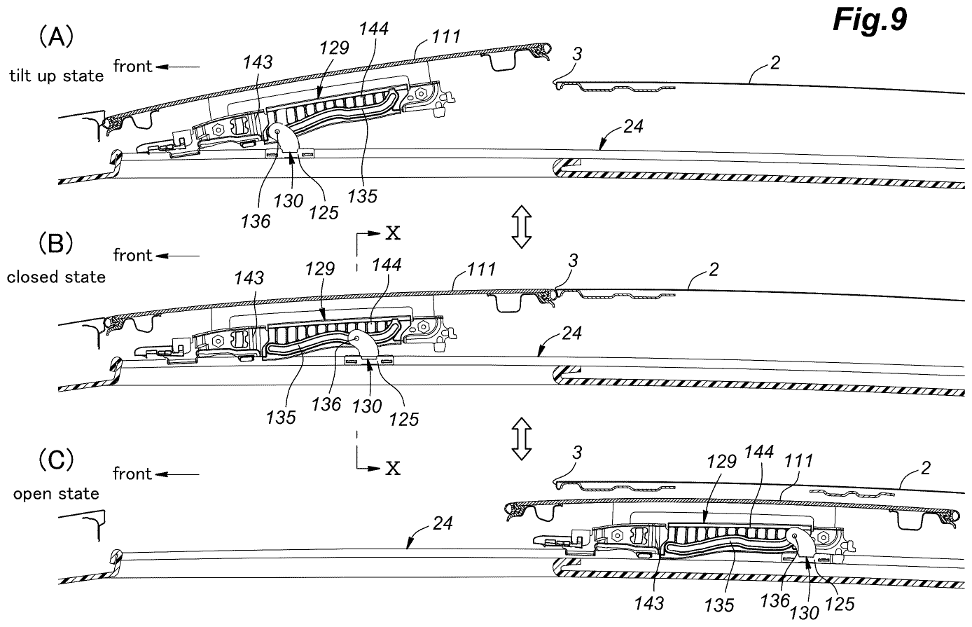

FIG. 9 is an operation explanatory diagram showing (a) a tilt up state, (b) a closed state, and (c) an open state of the sunroof device 110 shown in FIG. 8. As shown in FIG. 9(b), a slider 125 is provided in each guide rail 24 to be slidable in the front-rear direction. On the lower surface of the movable roof panel 111, left and right stays 129 for coupling the front panel 11 to the sliders 125 are fixed. Each stay 129 functions as a coupling member that couples the movable roof panel 111 to the slider 125. Between the slider 125 and the stay 129, an elevating mechanism 130 for raising and lowering the front panel 11 is provided.

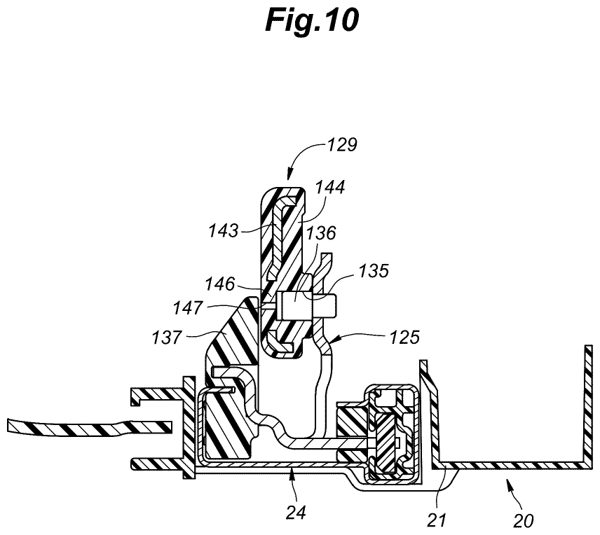

FIG. 10 is a sectional view taken along line X-X in FIG. 9. As also shown in FIG. 10, each stay 129 includes a sheet metal member 143 extending in the front-rear direction and a resin member 144 integrally formed on the sheet metal member 143. The resin member 144 of the stay 129 is formed with a bottomed cam groove 135 that is open to a side. The cam groove 135 has a length in the front-rear direction and the up-down direction. The slider 125 is integrally provided with a single guide pin 136 protruding laterally and a contact member 137 that opposes the stay 129 so as to contact the stay 129 in the protruding direction of the guide pin 136. With the guide pin 136 protruding into the cam groove 135 from a side, the slider 125 is slidably connected to the stay 129. The slider 125 supports the stay 129 with the single cantilever guide pin 136.

In the closed state of the sunroof device 110 shown in FIG. 9(b), the slider 125 is positioned in an intermediate portion in the front-rear direction with respect to the stay 129. The guide pin 136 is positioned in an intermediate portion of the cam groove 135 in the front-rear direction. In the tilt up state of the sunroof device 110 shown in FIG. 9(a), the slider 125 is positioned most forward, and is positioned most forward with respect to the stay 129 also. The guide pin 136 is positioned in a front end portion of the cam groove 135. In the open state of the sunroof device 110 shown in FIG. 9(c), the slider 125 is positioned most rearward, and is positioned most rearward with respect to the stay 129 also. The guide pin 136 is positioned in a rear end portion of the cam groove 135.

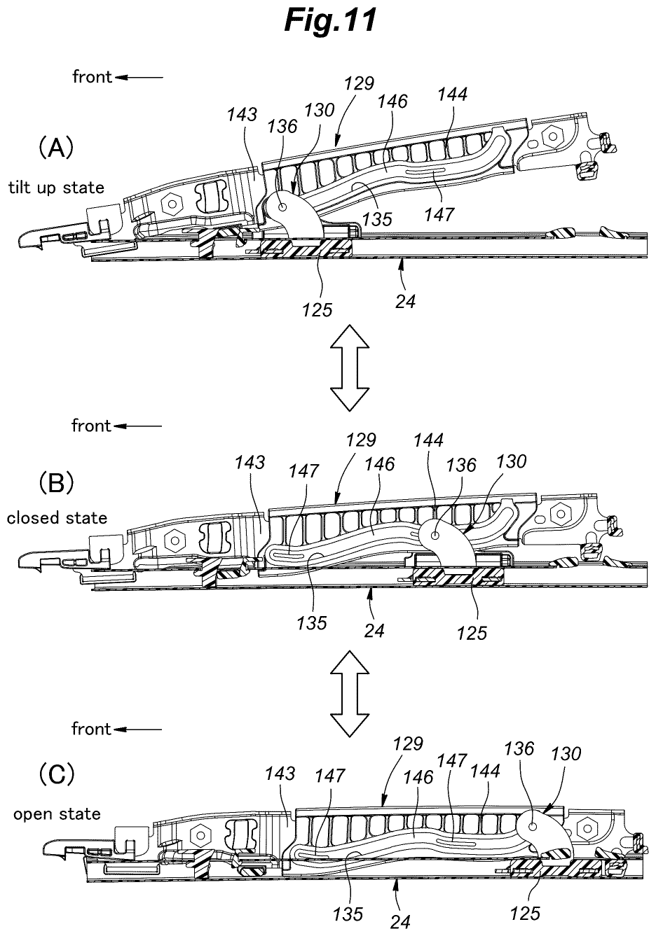

FIG. 11 is an operation explanatory diagram of the elevating mechanism 130, showing (a) the tilt up state, (b) the closed state, and (c) the open state corresponding to FIG. 9. A slot 147 is provided in the part of the bottom wall 146 where the guide pin 136 is positioned when the sunroof device 110 is in the closed state as shown in FIG. 11(b). A slot 147 is also provided in the part of the bottom wall 146 where the guide pin 136 is positioned when the sunroof device 110 is in the tilt up state as shown in FIG. 11(a). No slot 147 is provided in the part of the bottom wall 146 where the guide pin 136 is positioned when the sunroof device 110 is in the open state as shown in FIG. 11(c).

In other words, the bottom wall 146 of the cam groove 135 is formed with two slots 147 in positions spaced from each other in the extension direction of the cam groove 135. These slots 147 each extend in the extension direction of the cam groove 135 to have a length shorter than the length of the cam groove 135.

The sunroof device 110 is configured as described above. With such a configuration, the sunroof device 110 provides similar effects to those of the first embodiment.

Concrete embodiments have been described in the foregoing, but the present invention can be modified in various ways without being limited to the above embodiments. For example, in the above embodiments, the present invention was applied to the roof 2 of the automobile 1, but the present invention may be applied to a railroad vehicle, a tram, a trailer, or the like. The concrete structure, arrangement, number, material, etc. of each member or part may be appropriately changed without departing from the spirit of the present invention. Also, not all of the components shown in the foregoing embodiments are necessarily indispensable and they may be selectively adopted as appropriate.

### LIST OF REFERENCE NUMERALS

1 automobile
2 roof
3 opening
10 sunroof device
11 front panel (movable panel)
20 frame
24 guide rail
25 slider
27 rear slider
29 stay (coupling member)
30 elevating mechanism
32 rear link member (coupling member)
35 rear cam groove
36 rear guide pin
41 vertical wall portion
43 sheet metal member
44 resin member
46 bottom wall
47 slot
110 sunroof device
111 movable roof panel
125 slider
129 stay (coupling member)
130 elevating mechanism
135 cam groove
136 guide pin
146 bottom wall
147 slot

1. A sunroof device for at least partially opening and closing an opening formed in a roof of a vehicle with a movable panel, the sunroof device comprising:
a frame-shaped frame configured to be disposed below the roof to be aligned with the opening;
a slider provided on the frame to be slidable in a front-rear direction;
a coupling member coupling the movable panel to the slider; and
an elevating mechanism provided between the slider and the coupling member and configured to raise and lower a rear end of the movable panel to tilt the movable panel between a closed position where the movable panel closes the opening and a tilt up position where a rear portion of the movable panel is positioned above the opening,
wherein the elevating mechanism comprises:
a cam groove provided in one of the slider and the coupling member, the cam groove being a bottomed cam groove that is open to one side over an entire length thereof; and
an at least one guide pin provided on an other of the slider and the coupling member to protrude into the cam groove from a side, and
at least one slot is formed in a bottom wall of the one of the slider and the coupling member defining the cam groove, the at least one slot penetrating the bottom wall and extending in an extension direction of the cam groove to have a length shorter than a length of the cam groove, and the at least one slot being provided in a part of the bottom wall where the at least one guide pin is positioned when the movable panel is in the tilt up position.

2. The sunroof device according to claim 1, wherein the at least one slot is provided in a part of the bottom wall where the at least one guide pin is positioned when the movable panel is in the closed position.

3. The sunroof device according to claim 1, wherein the movable panel is supported on the frame to be movable between the closed position and an open position which is positioned in a moving direction of the slider with respect to the closed position in plan view, and
the at least one slot is not provided in a part of the bottom wall where the at least one guide pin is positioned when the movable panel is in the open position.

4. The sunroof device according to claim 1, wherein the coupling member includes a link member having one end pivotably coupled to the movable panel,
the guide pin includes two guide pins provided on the link member at positions spaced from each other in the extension direction of the cam groove, and
the at least one slot is provided in each of parts of the bottom wall where the two guide pins are positioned when the movable panel is in the tilt up position such that the slots are spaced from each other.

5. The sunroof device according to claim 4, wherein the at least one slot is provided in a part of the bottom wall where one of the two guide pins is positioned when the movable panel is in the closed position and is not provided in a part of the bottom wall where an other of the two guide pins is positioned when the movable panel is in the closed position.

6. The sunroof device according to claim 4, wherein the slider includes a sheet metal member and a resin member integrally formed on the sheet metal member, and
the cam groove is defined by the resin member so as to penetrate the sheet metal member in a plate thickness direction.

7. The sunroof device according to claim 4, wherein the slider includes a pair of vertical wall portions disposed on both sides of the link member and coupled to each other, the cam groove being formed in each of the pair of vertical wall portions,
the at least one guide pin protrudes from the link member to both sides so as to protrude into the cam grooves, and
the slot is formed in the bottom wall of each of the pair of vertical wall portions.
